(19) United States
(12) Patent Application Publication
(10) Pub. No.: US 2014/0153795 A1
(43) Pub. Date: Jun. 5, 2014

(54) PARAMETRIC IMAGING FOR THE EVALUATION OF BIOLOGICAL CONDITION

(71) Applicant: THE TEXAS A&M UNIVERSITY SYSTEM, College Station, TX (US)

(72) Inventor: MARK W. LENOX, College Station, TX (US)

(73) Assignee: THE TEXAS A&M UNIVERSITY SYSTEM, College Station, TX (US)

(21) Appl. No.: 14/088,530

(22) Filed: Nov. 25, 2013

Related U.S. Application Data
(60) Provisional application No. 61/731,525, filed on Nov. 30, 2012.

(51) Int. Cl. G06T 7/00

(52) U.S. Cl. CPC G06T 7/0012
USPC 382/128

(57) ABSTRACT

Systems and methods of performing parametric imaging are provided. According to an embodiment, data from multiple sources are combined using parametric equations to assign a probability value to each of a known set of diagnoses in a database. The system receives available data and applies the parametric equations based on the available data. As more data becomes available, the parametric equations can be reapplied to update the parameterized image. The parameterized image can be displayed overlaid on an anatomical image within a graphical interface.

### CROSS-REFERENCE TO RELATED APPLICATION

The present application claims the benefit of U.S. Provisional Application Ser. No. 61/731,525, filed Nov. 30, 2012, which is hereby incorporated by reference herein in its entirety, including any figures, tables, or drawings.

### BACKGROUND

Diseases often have a characteristic functional signature that can be measured in a variety of ways. For example, many cancers are hypermetabolic in that they use glucose at a rate far higher than the surrounding tissue. Based on this characteristic functional signature, clinicians often perform a positron emission tomography (PET) scan using FluoroDeoxyGlucose (FDG) as the tracer in order to highlight the glucose consumption in rendered images of the scan. Unfortunately, FDG also highlights everything else that uses glucose including, for example, the heart and brain. Furthermore, other diseases and conditions like arthritis and inflammation also indicate with FDG. Therefore, when a clinician evaluates such a PET scan, areas that could be indicative of cancer or other disease or conditions may be initially overlooked due to activity in other regions distracting the clinician from an efficient evaluation. Similar issues can arise in any number of tests attempting to identify a characteristic functional signature.

Although secondary sources of information may be sought and obtained and an iterative diagnostic process performed, a clinician currently makes a decision based on the direct outcome of some test, examination, or question presented to the patient. Thus, there continues to be a need in the art for techniques that can aid clinicians in their diagnostic process.

### BRIEF SUMMARY

Systems and methods for presenting probabilities of a disease to a user through the use of parameterized images and disease models are described herein. Various embodiments of the invention provide a graphical interface for clinicians to evaluate disease as part of their diagnostic process.

According to one aspect, parametrically calculated probabilities of a particular disease are presented to a medical professional as a parameterized image for use in analyzing and evaluating patient data to support diagnostic questions relating to a particular disease or condition. The parameterized image for a given indication can be based on information currently known and obtained regarding a patient or related to the patient's condition. Sources of information, including results of tests, imaging, and examination, may be stored in a file associated with a patient and accessed for use in performing the parametric imaging.

According to another aspect, data from multiple sources are combined to assign a probability value to each of a known set of diagnoses in a database. The combining can be weighted or unweighted and can be a sum, a product, an integration, a differentiation, or a combination thereof forming a parametric equation. The system receives available data and applies parametric equations based on the available data. As more data becomes available, the parametric equations can be reapplied to update the parameterized image.

According to another aspect, an interface is provided in which a medical professional can view parameterized images for a possible diagnosis. The parameterized image can include a 3D image volume that represents a diagnostic potential, or probability, for a given indication based on known information. The probability values represented in the parameterized image can be used to draw attention to particular spots in diagnostic images.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows a representation of a process by which a diagnosis is performed.

FIG. 2 shows a representational diagram of a weighting process used in the process by which a diagnosis is performed.

FIG. 3 shows a presentation of a process by which a parameterized image is formed in accordance with an embodiment of the invention.

FIG. 4 shows a process flow diagram in accordance with an embodiment of the invention.

FIG. 5 shows a schematic of a process by which a parameterized image is formed in accordance with an embodiment of the invention.

FIG. 6A shows an example PET image.

FIG. 6B shows a parameterized image according to an embodiment of the invention that may be overlaid the PET image of FIG. 6A.

FIG. 7 shows a computing environment in which a parametric imaging application of an embodiment of the invention may operate.

FIG. 8 shows a representation of a user interface in accordance with an embodiment of the invention.

### DETAILED DISCLOSURE

Anatomical imaging describes the physical structure of living and/or dead tissue. Functional imaging describes the measurement of certain characteristics of live tissue that have meaning beyond their physical structure. There are many functional characteristics that can be measured through a variety of means: metabolism, cell proliferation, perfusion, diffusion, and flow quantification among many more. These methodologies concentrate on a single idea to identify diseased tissue, and differentiate the diseased tissue from normal healthy tissue. The combination of multiple functional modalities can provide insight to subtle problems.

Furthermore, current imaging modalities are tied to the physics upon which they are premised. For example, computed tomography (CT) presents data in the form of Hounsfield units, and PET presents data in the form of standard uptake values (SUVs). Although these imaging modalities are often thought of as being anatomical in nature, the data values for these imaging modalities do not themselves represent normal/abnormal or healthy/diseased. Rather, a person reading the values interprets the data based on context and experience. In certain cases, a direct diagnosis can be derived from the images.

For example, an x-ray can show whether a bone is broken by indicating the physical deformation that is readily understood by a person viewing the image. In other cases, a diagnosis is not as obvious and requires information derived from multiple sources, including past experience, to derive a differential diagnosis and a list of likely diagnoses.

A “differential diagnosis” refers to a diagnostic method in which a most likely diagnosis (or a shorter list of possible diagnoses) is obtained by a process of elimination, for example, where a clinician weighs a list of likely diagnoses and prioritizes the diagnoses with a weighting process based on very diffuse probabilities (e.g., from 0% to 100%) to come to a diagnosis they believe most likely.

A differential diagnosis is an iterative process, such that as new information is introduced, the list of possible diagnosis either gets shorter, or the contents are rearranged with higher probabilities until a sufficiently high confidence level is achieved. Once a sufficiently high confidence level is achieved, a clinician may act on that probability.

For example, a mass in the pancreas region on a CT scan may be related to pancreatic cancer. A PET study can then be performed, and increased glucose metabolism in that area can be indicative of pancreatic cancer. Once it is supposed that a patient may have pancreatic cancer, a more exacting diagnosis may be obtained by performing a PET study using a liposome with targeting that attracts it to pancreatic cancers such that only the areas that are diseased with that cancer type are highlighted.

Imaging tools are available to improve resolution and specificity, as well as to reduce noise, to help in facilitating a reading of data from an imaging modality. However, as previously mentioned many tests indicate for multiple conditions and/or involve subtle or indirect indications. In order to aid a clinician or other medical professional with their diagnosis, various embodiments of the invention provide systems and methods for presenting probabilities of a disease through the use of parameterized images and disease models.

To provide parametric imaging in accordance with embodiments of the invention, biological processes are mathematically modeled and used to create a parameterized image that represents the probability of a particular disease type.

A “parameterized image” is an image that is not made up of a direct measurement, but is a combination of information (parameters) from several sources of the same area/volume (as well from the body as a whole). The combining of the information (parameters) can be performed using a mathematical transform in a weighted or non-weighted fashion, a sum, a product, an integration, a differentiation, or some other mathematical approach depending on the desired disease indication. The parameterized image can also be formed in two, three, or four dimensions (time).

A “parametric equation” provides the combination of all inputs and their mathematical transforms used to build a given parameterized image. Thus, a parametric equation can be thought of as a weighted checklist that mathematically combines the available information from all appropriate sources based on the disease model for a particular diagnostic indication.

In accordance with an embodiment of the invention, a system is provided that combines diagnostic information from at least two sources to present the diagnostic information to clinicians in a manner that can be used in the clinicians' evaluation of disease as part of their diagnostic process. In certain embodiments, the system can facilitate efficient diagnosis by providing evaluation tools and a graphical interface.

According to one embodiment, an interface is provided that presents a standardized evaluation for a plurality of diseases. By combining information from unrelated sources with a mathematical representation of the disease, multiple diagnostic questions can be answered in a very short period of time. Many diseases are not specifically identified by a single test, but require multiple tests to identify. Thus, as part of the diagnostic process of singling out a particular diagnosis out of many possible diagnoses, a standardized evaluation can greatly assist the clinician by making sure to take into consideration all possibilities.

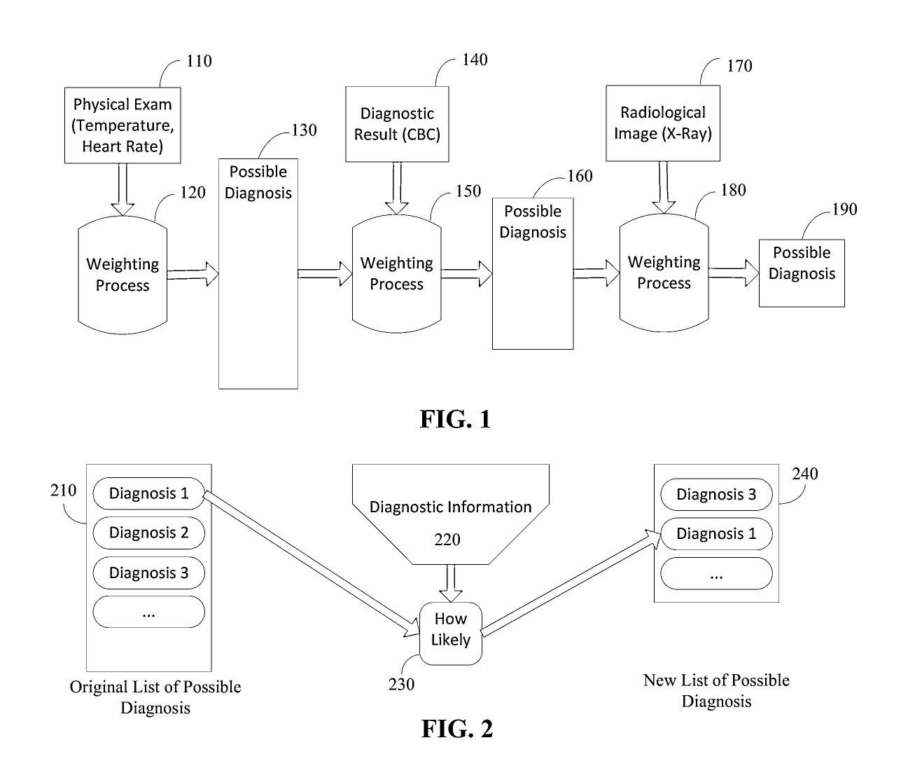

FIG. 1 illustrates a process used by clinicians to diagnose a disease. As shown in FIG. 1, the thought process of a clinician who diagnoses a disease is a combinatorial process that involves multiple inputs such as results of a physical exam 110, a diagnostic test 140 (such as a complete blood count (CBC) test), and radiological images 170, as well as information derived from past experience, to derive a differential diagnosis.

For example, as information is introduced, a weighting process is performed to reduce and/or reorganize possible diagnoses. In the example shown in FIG. 1, a weighting process 120 may be performed using the information received by the results of a physical exam 110 to obtain a first list of possible diagnoses 130. Based on at least one of the more probable diagnoses of the first list of possible diagnoses 130, additional tests may be performed to rule out or support a diagnosis. Here, a weighting process 150 is again performed, but using the information received from results of a diagnostic test 140 to reduce and/or rearrange the first list of possible diagnoses 130 to a second list of possible diagnoses 160. From the second list of possible diagnoses 160, additional information can be searched and obtained to further reduce the list. For example, a radiological image 170 can be obtained and the information from the image used in a weighting process 180 to reduce and/or rearrange the second list of possible diagnoses 130 to a third list of possible diagnoses 190. This process may be repeated until a sufficiently high confidence level is achieved for a particular diagnosis.

It should be understood that the order of introducing information is not intended to be limiting. Rather, the process shown in FIG. 1 is merely provided as one example of data gathering and one or more of physical exam, diagnostic testing, and radiological imaging may be performed as available to the clinician or as prompted to eliminate or confirm a diagnosis.

As described with respect to FIG. 1, at each step of the diagnostic thought process, a weighting process (e.g., 120, 150, 180 of FIG. 1) is performed. A more detailed view of the weighting process is shown in FIG. 2. Referring to FIG. 2, the weighting process is performed by taking a known list of possible diagnoses 210 into consideration, and sorting the possible diagnoses 210 based on the probability of a fit 230. In certain cases, the list of possible diagnoses may originally begin with all known medical diagnoses. In other cases, the list of possible diagnoses may begin with a list based on pre-existing information already received and processed.

The original list of possible diagnoses 210 is examined item by item, and compared with available diagnostic information 220 to form a new list of possible diagnoses 240. The new list is likely shorter, as some possible diagnoses are thrown out as a function of the input diagnostic information.

When performed in practice, this weighting process can take considerable time, and may be subject to error because each evaluation must take into account all information available up to that point, and it is generally the sole responsibility of the clinician to maintain the integrity of the process and interpret the results (particularly where the selection of a diagnosis is being performed over a period of time and is subject to the thought processes of the clinician). Forgetting a small detail can lead to an incorrect evaluation.

Embodiments of the invention provide systems and techniques that can enhance the ability of a clinician to perform the weighting and decision making process in a quicker and more accurate manner as more information becomes available.

In accordance with one embodiment of the invention, once initial screening diagnostics are performed for a patient, the data from the screening diagnostics is used to create parameterized images for displaying to a clinician or other medical professional.

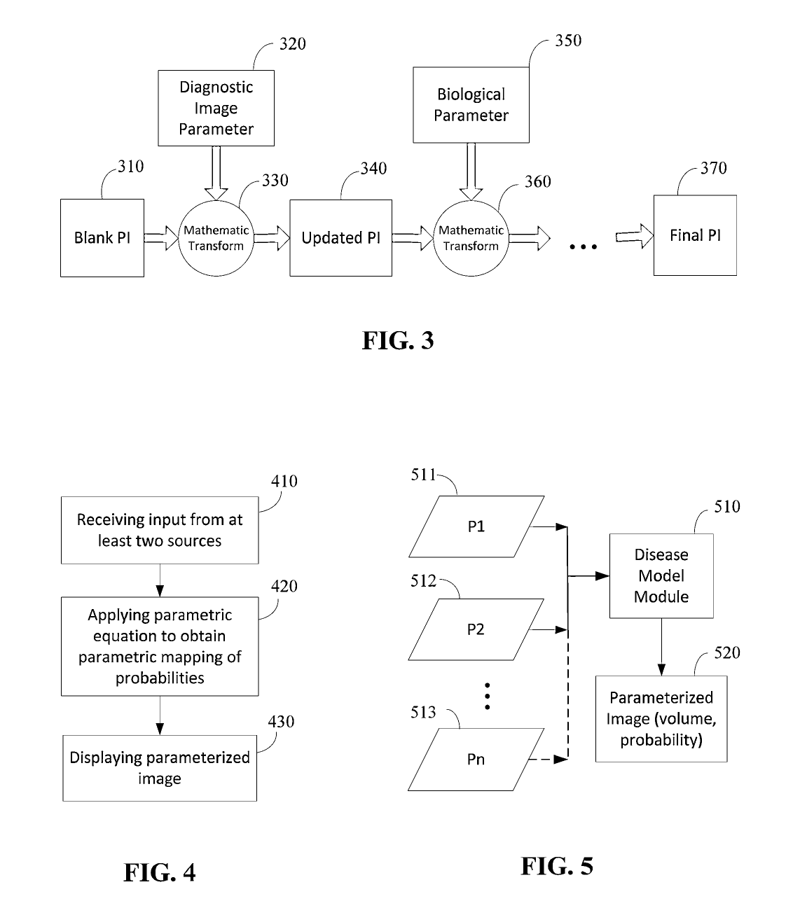

FIG. 3 illustrates a parametric imaging process in accordance with an embodiment of the invention. Referring to FIG. 3, starting with a blank parameterized image (PI) 310, a parameter from, for example, a diagnostic image 320 is used to update the blank PI 310 through performing a mathematical transform 330 of the parameter from the diagnostic image 320. Next, biological parameters 350 can be included and a mathematical transform 360 performed that combines the previous parameters in the updated PI 340 with the biological parameters to further modify the PI. For each additional information source (including additional tests as well as parameters obtained from physical examination and prior history), the previous information is carried through via the PI until a final PI 370 is obtained. The PI may be displayed on its own or fused with anatomical information.

Parameters used in the mathematical transforms (e.g., 330, 360) can come from a variety of sources. Diagnostic image parameters can be generated through the use of procedures such as PET, Ultrasound, CT, magnetic resonance imaging (MRI), and X-ray, as well as other imaging procedures that measure specific values for one or more locations in the body. Biological parameters include parameters taken to represent the whole body, and represent values obtained from blood chemistry and CBC counts. For example, temperature, blood pressure, white blood cell count, etc. Biological parameters can also include genetic information (e.g., DNA sequence data). Exam parameters represent input from a clinician on information such as prior history, including medical history, and input from a physical examination. Medical history can include prior test data, family history, and previous medical records. Of course, any use of a patient's records should follow appropriate privacy guidelines such as the Health Insurance Portability and Accountability Act of 1996 (HIPAA) Privacy and Security Rules.

According to various embodiments of the invention, the parameterized image is mapped to a portion/region of an anatomy in a manner that all data corresponding to a particular portion/region of the anatomy is used in forming the parameterized image for that portion/region.

In one embodiment such as shown in FIG. 4, a method of performing parametric imaging can include receiving, as input, data from at least two sources 410; and applying the parametric equations for some, all, or a selected one or more diseases to obtain parametric mapping of probabilities 420. When applying the parametric equations, calculations are performed using the data to transform the data and form a parameterized image. The data representing the parameterized image is rendered to display the parameterized image 420. Methods of performing parametric imaging can be provided as a computer program or module embodied on a computer-readable medium that, when executed performs parametric imaging for displaying a parameterized image either within existing graphical interfaces or on a separate graphical interface.

FIG. 5 shows a schematic of a process by which a parameterized image is formed in accordance with an embodiment of the invention. Referring to FIG. 5, a disease model module can include one or more disease models that are optimized to be highly specific for a corresponding disease. The disease models may be provided to a user and stored in a local database for ease of access by a parametric imaging application running on a computer system. To form a parameterized image, information from at least two data sources 511, 512 is combined together using one or more mathematical transforms applied according to the disease model module 510 to provide a final image volume that represents the probability of a disease (parameterized image 520). As new data sources 513 are added, the information from the data sources 511, 512, 513 is combined using one or more mathematical transforms applied according to the disease model module 510 to form a parameterized image 520. In this manner, all available data on a patient may be used every time the parametric imaging application is run. In some cases, a computer system on which the parametric imaging application is running can access a secure medical database storing medical history and lab data for a patient.

According to an embodiment, the parametric equations are provided according to disease. For example, each type of cancer may have a corresponding parametric equation. Diabetes, and Alzheimer's disease, and other diseases would have their own corresponding parametric equations. Thus, when the disease model module is run, the disease model module obtains the appropriate parameters from the various data sources and applies the corresponding parametric equation in order to output a parameterized image. A parameterized image can be generated for a particular diagnostic indication using all, some, or selected ones of the available parametric equations in the disease model module.

According to one embodiment, the information for each possible diagnosis is presented as a parameterized image that represents a diagnostic potential, or probability, for a given indication based on all relevant information currently known. As the diagnostic process moves forward in time and more information is known, the known information can be re-evaluated for each possible diagnosis, generating a new parameterized image automatically, ensuring that nothing is left out. As long as a model of a particular disease is provided in a database for use by the system, a parameterized image can be generated for each possible diagnosis.

The model of a disease used to create the parameterized image includes a parametric equation. Each model is disease specific and it is contemplated that as studies arise that show links between various biological functions and healthy/diseased state, the parametric equations forming the models will be updated and/or adjusted to further facilitate a clinician's diagnosis.

Accordingly, certain embodiments leverage existing and future tests and mathematical models of biological function in order to indicate healthy/diseased tissue state for a chosen indication. In this way, a variety of information can be rapidly combined in different permutations to give the clinician a way to differentiate between varieties of indications that can occur. For example, multiple imaging techniques and diagnostics can be combined in a way that highlights indicia of the disease and suppresses indicia of normal function.

A variety of information can be combined to produce a parameterized image. These include, but are not limited to, 2D and 3D diagnostic imaging modalities such as CT (density), MRI (proton density, diffusion, perfusion, spectroscopy), PET (glucose metabolism, rate of cell proliferation), Ultrasound (blood velocity), for measurement of specific information in a specific location. Their values at a specific point in time and how those values change with time are also parameters.

That is, diagnostic imaging includes PET, CT, MRI, X-ray, and other techniques that can provide both anatomical (structural) and functional information for use with the subject parametric imaging systems. This anatomical and functional information is not specific to a disease diagnosis, but general in nature, and represents a two-dimensional (2D), three-dimensional (3D), or four dimensional (4D) (time) evaluation of a particular part of the body for specific parameters depending on the scan.

In addition, biological parameters represent general information about the whole body, such as temperature, blood pressure, heart rate, genetic information, and diagnostic tests such as blood chemistry, CBC counts and other assays that represent parameters that can affect diagnosis of disease anywhere in the body. These parameters can also be measured as a function of time, and their characteristics with respect to time can also be parameters.

Exam parameters include known medical history of the patient, as well as information deduced by the examining clinician.

In accordance with embodiments of the invention, at least two sources of information are used to input parameters forming the PI. The at least two sources can provide diagnostic image parameters, biological parameters, exam parameters, or a combination thereof. As one example, two sources, each providing diagnostic image parameters may be used. As another example, two sources, each providing biological parameters may be used. As yet another example, two sources, one providing diagnostic image parameters and the other providing biological parameters may be used. In a further example, two parameters, one providing diagnostic image parameters and the other providing exam parameters may be used. As another example, three sources, one providing diagnostic image parameters, a second providing biological parameters, and a third providing exam parameters may be used.

In accordance with embodiments of the invention, a parameterized image is provided that has information content and a normalized value that is designed to highlight a particular disease. This can be considered a relative probability of one disease versus normal function.

A parameterized image is made up of a combination of diagnostic images, mathematical models (transform between parameter and PI) of disease, and biological parameters that are specifically applied to a particular disease diagnosis question. Multiple parameterized images can be combined either linearly or nonlinearly to create a new image that is specific to identify desired disease characteristics.

PIs can mimic part of the natural process that the experienced clinician performs as a part of the diagnostic process, making it easier for a clinician to test multiple possible diagnoses.

It is possible that a patient could have multiple diseases in the same and/or different locations within the body. By using systems and methods of the invention, enhanced efficiency in testing through the use of parameterized image can improve diagnostic understanding by the clinician. This is done by making sure all parameters are re-evaluated as more information is known at each stage of the diagnostic process. The re-evaluation can be performed automatically upon uploading (or downloading) new data.

In accordance with certain embodiments of the invention, the parameterized image highlights the disease and suppresses normal function. That is, the parameterized images direct a clinician to areas that indicate higher probabilities of a particular disease while drawing attention away from areas indicative of normal function. The techniques do not directly modify or improve existing imaging processes. Rather, the techniques described herein overlay a probability map onto existing imaging modalities to direct a clinician to areas of interest using secondary, tertiary and further information external to the imaging modality.

By parametrically combining diverse information to form a three dimensional map associated with an area of interest (the parameterized image), a tool facilitating the evaluation of probable diagnoses can be provided to a clinician without resorting to a very large number of very specific tests. In certain cases, a clinician is able to ask another diagnostic question using the same dataset, but calling a different disease model module. Parameters for that particular disease/diagnosis can be utilized to form another three dimensional map associated with an area of interest without necessarily requiring a clinician to perform a new battery of tests. Accordingly, various embodiments of the invention facilitate a clinician's diagnostic process shown in FIG. 1 such that the clinician can work his or her way through a list of possible diagnoses at each stage in a consistent, thorough, and efficient way.

A greater understanding of the present invention and of its many advantages may be had from the following examples, given by way of illustration. The following examples are illustrative of some of the methods, applications, embodiments and variants of the present invention. They are, of course, not to be considered in any way limitative of the invention. Numerous changes and modifications can be made with respect to the invention.

### EXAMPLE

### Parameterized Image for Osteosarcoma

In a case where a patient presents with pain in or near a joint and a CT scan shows no physical problem with the joint indicative of cartilage, ligament, or tendon damage, but bone proliferation is noted as would be typical for osteosarcoma, an FDG PET study may be requested to screen for osteosarcoma. An MRI perfusion study may also be requested in which a contrast agent that changes the magnetic susceptibility of blood is used to indicate blood delivery in the tissue.

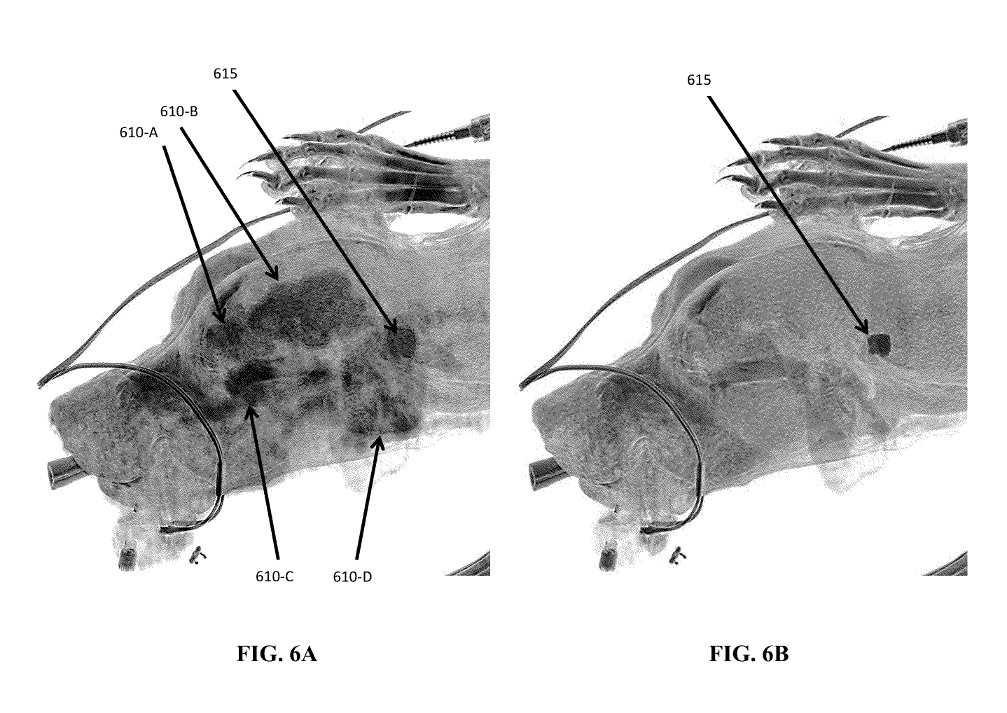

The FDG PET scan is useful for identifying cancers because many cancers are hypermetabolic—using glucose at a rate far higher than the surrounding tissue. However, FDG also highlights everything else in the patient that uses glucose including the heart and brain. Moreover, other diseases and conditions such as arthritis and inflammation also indicate with FDG. Therefore, when a clinician views the PET scan images, the areas indicating high glucose use do not necessarily represent regions that may be cancerous. FIG. 6A shows an example FDG PET scan of a dog. As can be seen from the image, many areas, including near the brain (610-A and 610-B) and areas having inflammation (e.g., 610-C and 610-D) indicate with FDG. The many areas that indicate with FDG can distract from a potential indicator of a cancerous region (e.g., region 615).

In accordance with an embodiment, a clinician can access a parametric imaging application via an interface within the imaging software on which the PET scan is being displayed and make either a specific request for probabilities of osteosarcoma or a general request as to whether a cancer is probable for the patient.

Upon receiving the request from the clinician, the parametric imaging application obtains the appropriate parameters from the information either input by the clinician or stored as part of the patient's file. For creating a parameterized image for osteosarcoma, the application obtains the SUV from the PET scan and a perfusion value from the MRI. SUV is a normalized functional parameter of glucose metabolism that has been corrected for weight and dose. In one embodiment, the disease model for osteosarcoma includes normalized products of each parameter type (e.g., the parametric equation for osteosarcoma may include the combination of the perfusion value and the SUV for a given region).

The resulting products are transformed into a 3D volume that can be overlaid on a display of the patient's anatomy. The volume can be sized in various regions of the patient's displayed anatomy according to likelihood of disease (for example a probability above a particular threshold). The parameterized image can provide a probability and fit of confidence.

For example, at a region indicated in the FDG PET study as having a high SUV and having a corresponding good blood vascularity by the MRI perfusion study, an overlaid volume (parameterized image) with information content (such as text or color) and a normalized value can be provided by the parametric imaging application to show that the region may have a high probability of osteosarcoma. FIG. 6B shows an example parameterized image. As can be seen from FIG. 6B, the regions in which indicate with FDG but do not result in a high probability of osteosarcoma are suppressed. Instead, the region 615 appears and can be used to draw the practitioner's attention to a region that may be of interest for a particular disease or condition.

Low perfusion combined with low SUV would be indicative of a chondrosarcoma instead of osteosarcoma and those regions may be overlaid with a volume indicative of a probability of chondrosarcoma.

Because the parameterized image presents the normalized products of the types used to determine the diagnosis (the “and” clause), the parameterized image suppresses regions with high SUV due to inflammation as well as other normal function, and enhances regions with high SUV due to osteosarcoma.

### EXAMPLE

### Computing Environment

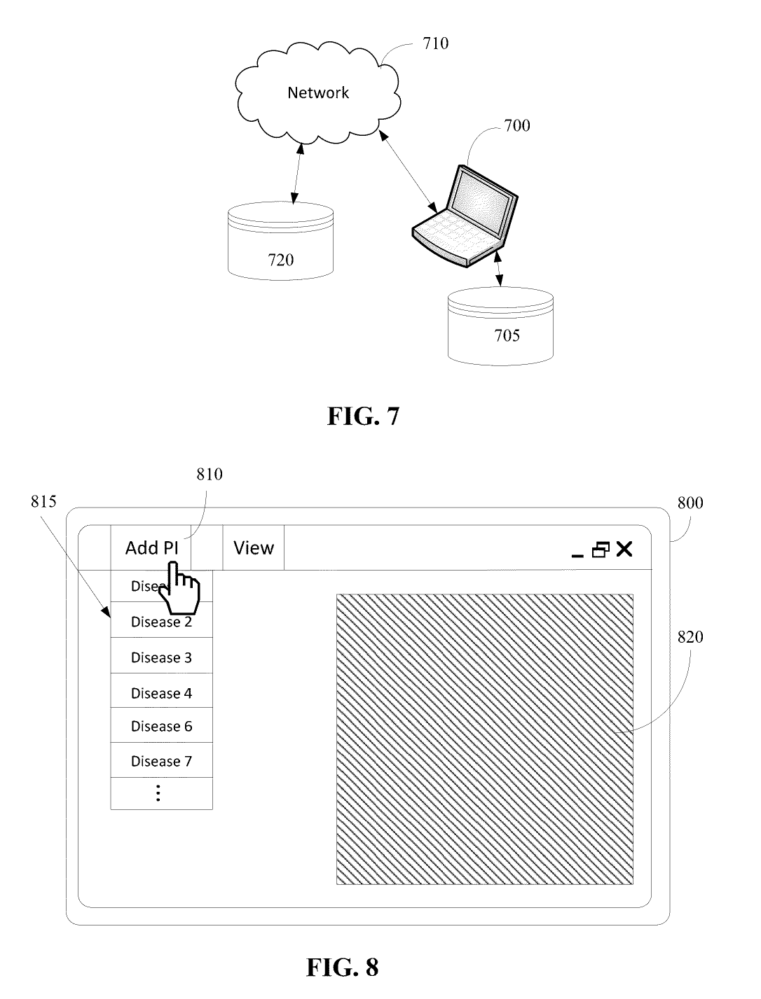

FIG. 7 shows a computing environment in which a parametric imaging application of an embodiment of the invention may operate. Referring to FIG. 7, a clinician may use a computing system 700 embodied, for example, as a workstation, a laptop, desktop, tablet, etc. Disease models can be stored in a database 705 in communication with the computing system 700. The database 705 can be stored as part of internal storage of the computing system 700 or, in other cases, external to the computing system 700 by being connected to an I/O port of the computing system by wired or wireless connections. In some embodiments, the disease models can be provided over a network 710 to the computing system 700. The disease models can be stored in a remote database 720 that can be managed by a server (not shown). The computing system can access the database 720 when forming parameterized images or simply to search for updates to the disease models for storing in the local database 705.

### EXAMPLE

### User Interface

FIG. 8 shows a representation of a user interface in accordance with an embodiment of the invention. Referring to FIG. 8, a parametric imaging application can be launched either within an imaging interface or as a separate window on a display 800. When a user makes a selection to add a parameterized image (Add PI) 810, a drop down menu 815 can be provided with available disease models. A selection of one of the disease models by a user inputs the request to the parametric imaging application and the appropriate function is applied using the data available to the parametric imaging application. The resulting parameterized image can be provided at the graphic region 820 in which 2D and 3D anatomical images may be viewed. The parameterized image can be provided as a layer on the 2D or 3D anatomical image (which may be a generic representation of anatomy or rendered images from a CT, PET, MRI or other imaging modality). Multiple disease models may be selected and the resulting parameterized image provided as a layer on the graphic region 820.

In another embodiment, all or some of the available disease models are automatically run upon launch of the parametric imaging application and the parameterized images displayed at the graphic region 820. Then, the selection of a disease model via the Add PI 810 can cause the particular parameterized image for that disease to be shown on the graphic region 820 for closer inspection without other parameterized images.

In certain embodiments, when a particular disease model is selected but not all of data for performing the calculations by the parametric imaging application is available, a message can be displayed indicating the particular information or data that is needed for applying the function. Similarly, a user can determine what information may be needed for a particular model by selecting the model or an associated graphical interface in order to have the requested information (e.g., variables) displayed. For example, if temperature is a variable in one of the disease models, but there is no temperature data stored or entered by the user, then the system can display a message requesting input of temperature. An input field may be provided for the user to include the information.

In one embodiment, the parameterized image is a 3D image volume representing a probability. In another embodiment, the parameterized image is a 2D image where color, pattern, brightness or other aspect is used to represent probabilities.

In one embodiment, a default or suggested display setting can be provided based on results of performing the parametric imaging for quick diagnosis of a probable issue.

Certain techniques set forth herein may be described in the general context of computer-executable instructions, such as program modules, executed by one or more computers or other devices. Generally, program modules include routines, programs, objects, components, and data structures that perform particular tasks or implement particular abstract data types. Certain methods and processes described herein can be embodied as code and/or data, which may be stored on one or more computer-readable media. Certain embodiments of the invention contemplate the use of a machine in the form of a computer system within which a set of instructions, when executed, can cause the system to perform any one or more of the methodologies discussed above.

In some embodiments, the machine/computer system can operate as a standalone device. In some embodiments, the machine/computer system may be connected (e.g., using a network) to other machines. In certain of such embodiments, the machine/computer system may operate in the capacity of a server or a client user machine in server-client user network environment, or as a peer machine in a peer-to-peer (or distributed) network environment.

The machine/computer system can be implemented as a desktop computer, a laptop computer, a tablet, a phone, a server, or any other machine capable of executing a set of instructions (sequential or otherwise) that specify actions to be taken by that machine, as well as multiple machines that individually or jointly execute a set (or multiple sets) of instructions to perform any one or more of the methods described herein.

The computer system can have hardware including one or more central processing units (CPUs) and/or digital signal processors (DSPs), memory, mass storage (e.g., hard drive, solid state drive), I/O devices (e.g., network interface, user input devices), and a display (e.g., touch screen, flat panel, liquid crystal display, solid state display). Elements of the computer system hardware can communicate with each other via a bus.

When a computer system reads and executes instructions that may be stored as code and/or data on a computer-readable medium, the computer system performs the methods and processes embodied as data structures and code stored within the computer-readable medium.

Computer-readable media includes storage media in the form of removable and non-removable structures/devices that can be used for storage of information, such as computer-readable instructions, data structures, program modules, and other data used by a computing system/environment. By way of example, and not limitation, a computer-readable storage medium may include volatile memory such as random access memories (RAM, DRAM, SRAM); and non-volatile memory such as flash memory, various read-only-memories (ROM, PROM, EPROM, EEPROM), magnetic and ferromagnetic/ferroelectric memories (MRAM, FeRAM), and magnetic and optical storage devices (hard drives, magnetic tape, CDs, DVDs); or other media now known or later developed that is capable of storing computer-readable information/data for use by a computer system. “Computer-readable storage media” should not be construed or interpreted to include any carrier waves or propagating signals.

Furthermore, the methods and processes described herein can be implemented in hardware modules. For example, the hardware modules can include, but are not limited to, application-specific integrated circuit (ASIC) chips, field programmable gate arrays (FPGAs), and other programmable logic devices now known or later developed. When the hardware modules are activated, the hardware modules perform the methods and processes included within the hardware modules.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

It should be understood that the examples and embodiments described herein are for illustrative purposes only and that various modifications or changes in light thereof will be suggested to persons skilled in the art and are to be included within the spirit and purview of this application.

1. A system for performing parametric imaging, comprising:
one or more computer-readable storage media having instructions stored thereon that when executed by a computing device cause the computing device to:
receive data corresponding to a patient, the data providing at least two parameters;
apply a set of parametric equations to the data to form a parameterized image, each parametric equation providing a parametric mapping of a probability of a particular disease; and
display the parameterized image.

2. The system according to claim 1, further comprising:
a database of disease models in which the set of parametric equations are stored.

3. The system according to claim 1, wherein the at least two parameters each comprise a parameter selected from the group consisting of a diagnostic image parameter, a biological parameter, and an exam parameter.

4. The system according to claim 3, wherein the diagnostic image parameter comprises a parameter associated with positron emission tomography (PET), computed tomography (CT), magnetic resonance imaging (MRI), X-ray, or ultrasound.

5. The system according to claim 3, wherein the biological parameter comprises blood pressure, heart rate, temperature, blood chemistry, genetic information, or complete blood count (CBC).

6. The system according to claim 3, wherein the exam parameter comprises an item from a medical history of the patient.

7. The system according to claim 1, wherein the parameterized image comprises a volume having a value indicative of the probability for the particular disease.

8. The system according to claim 1, wherein the parameterized image is overlaid on an anatomical image within a graphical user interface.

9. A method of performing parametric imaging, comprising:
receiving data corresponding to a patient, the data providing at least two parameters;
applying a set of parametric equations to the data to form a parameterized image, each parametric equation providing a parametric mapping of a probability of a particular disease; and
displaying the parameterized image.

10. The method according to claim 9, wherein applying the set of parametric equations to the data comprises applying a sum, a product, an integration, a differentiation, or a combination thereof to the data.

11. The method according to claim 9, wherein the at least two parameters each comprise a parameter selected from the group consisting of a diagnostic image parameter, a biological parameter, and an exam parameter.

12. The method according to claim 11, wherein the diagnostic image parameter comprises a parameter associated with positron emission tomography (PET), computed tomography (CT), magnetic resonance imaging (MRI), X-ray, or ultrasound.

13. The method according to claim 11, wherein the biological parameter comprises blood pressure, heart rate, temperature, blood chemistry, genetic information, or complete blood count (CBC).

14. The method according to claim 11, wherein the exam parameter comprises an item from a medical history of the patient.

15. The method according to claim 9, wherein displaying the parameterized image comprises displaying a volume having a value indicative of the probability for the particular disease.

16. The method according to claim 9, wherein displaying the parameterized image comprises displaying the parameterized image overlaid on an anatomical image within a graphical user interface.

17. The method according to claim 9, further comprising:
receiving new data corresponding to the patient;
applying the set of parametric equations to the data and the new data to form an updated parameterized image; and
displaying the updated parameterized image.

18. A system comprising:
one or more computer-readable storage media;
a parametric imaging application stored on the one or more computer-readable storage media that, when executed by a processor, causes the processor to perform a method comprising:
displaying a first view comprising a disease model selection element and a graphic region; and
in response to receiving a selection of a disease model from a plurality of available disease models available through the disease model selection element, retrieving a patient's data corresponding to one or more parameters for a parametric equation of the disease model, calculating the parametric equation using the patient's data; and rendering a parameterized image in the graphic region.

19. The system according to claim 18, wherein the graphic region further comprises a 2D or 3D anatomical image on which the parameterized image is overlaid.

20. The system according to claim 18, wherein the parametric imaging application causes the processor to perform the method further comprising:
determining whether the patient's data is sufficient or insufficient for calculating the parametric equation; and
in response to determining that the patient's data is insufficient, displaying a message indicating that a particular information or data is needed.
